(19) United States
(12) Patent Application Publication
(10) Pub. No.: US 2007/0124163 A1
(43) Pub. Date: May 31, 2007

(54) System and method for active documentation of charitable activities

(76) Inventor: Patrick Ehring, Bonn (DE)

Correspondence Address: PERKINS COIE LLP, P.O. BOX 2168, MENLO PARK, CA, 94026, US

(21) Appl. No.: 11/601,463

(22) Filed: Nov. 16, 2006

Related U.S. Application Data
(60) Provisional application No. 60/737,520, filed on Nov. 16, 2005.

(51) Int. Cl. G06Q 99/00

(52) U.S. Cl. 705/1

(57) ABSTRACT

A computer implemented business method for providing an independent source of information regarding the charitable activities of a plurality of members is presented. The method connects an interested party with an authoritative reference for charitable giving.

### RELATED APPLICATIONS

This application claims the benefit of priority to U.S. Provisional Application Ser. No. 60/737,520, filed Nov. 16, 2005, which is incorporated herein by reference in its entirety.

### BACKGROUND

Many companies demonstrate social responsibility through diverse involvement in charitable activities. For example, companies donate money and make in-kind transfers, provide services free-of-charge, release employees to work charitable matters, sponsor schools and universities, and serve as patrons of art and music.

The subject of corporate social responsibility and how companies use it in their marketing and communication activities is a practice known as “cause related marketing.” Increasingly, philanthropy is used as a form of public relations or advertising, promoting a company's image through high-profile sponsorships (Porter, M. E., “The Competitive Advantage of Corporate Philanthropy,” Harv. Bus. Rev. 80(12), 56-68 (2002)).

Corporate social responsibility in the form of corporate philanthropy, or donating to charities, has been practiced since as early as the late 1800s at least in the United States (Sethi, S. P., “Advocacy Advertising and Large Corporations,” Lexington Books, Lexington, Mass. (1977)). It was legitimate insofar that it directly benefited the shareholders, and corporate donations were mostly on the agenda of those companies that could afford it. The modern concept of corporate social responsibility was developed primarily during the 1960s in the United States with the notion that corporations have responsibilities that go beyond their legal obligations (Vrioni, A. B. and Bronn, P. S., “Corporate Social Responsibility and Cause Related Marketing,” International Journal of Advertising Vol. 20, No. 2 (2001)).

Reputation, closely related to brand awareness, aids in brand differentiation and ultimately helps a company gain (through a good reputation) or lose (through a damaged reputation) competitive advantage (Kay, J., “Foundations of Corporate Success,” Oxford, Oxford, UK (1993)). It has been said that well-reputed firms have a competitive advantage within their industries, but poorly reputed firms are disadvantaged (Fombrun, C. J. and Shanley, M., “What is in a name? Reputation building and corporate strategy,” Academy of Management Journal, Vol. 33, No. 2 (1990)).

Surveys have shown that most of consumers favor socially responsible companies and products (Roper Starch Worldwide, “Cause Related Marketing: A Survey of American Customers' Attitude,” RSW Inc., New York (1993)). In fact, one third of Americans say that after price and quality, a company's responsible business practices are the most important factor in deciding whether or not to buy a brand, and if price and quality are equal, they are more likely to switch to a brand which had a cause related marketing benefit. A German study has shown that one third of German consumers have purchased another brand or have even changed brands because a particular company is engaged in social activities (Broberg, M. P. “Corporate Social Responsibility in the European Communities-the Scandinavian Viewpoint”, Journal of Business Ethics, 15(6), 615-625 (1996)).

The recent Rio World Summit on Sustainable Development and Agenda 21 embraced the ecological, social and economic activities of corporations. There, policy-makers discussed the fact that corporations seek to align environmental responsibility with business success. These discussions indicate that there is a readiness to publish corporate activities in a transparent manner. The vehicle of presentation of these activities is of fundamental importance as it concerns the creditability and acceptance of corporate images. The variety of specialist terminology and wide range of activities, however, suggests that the possibility of an understandable presentation could be lost.

Accordingly, there is increasing interest in integrating and publicizing social activities into the marketing strategies of diverse corporations. At the same time, social engagements appear to be quite difficult to integrate into marketing strategies. For this reason, companies frequently devote significantly more money to publicity-effective sports sponsoring, even though companies primarily declare that their intention is to support charitable purposes.

Thus, charitable organizations are searching for ways to provide commercial donors with an additional benefit. This may involve leveraging corporate charitable activities to improve status, as compared to sports sponsoring, for example. Some donating organizations have noticed this shortcoming and market a logo themselves for a licensing fee. For example, the World Wildlife Fund and SOS Children's Villages use their own charitable logos. The result, however, is that companies are either bound to a label or end up, over time, using a large number of labels at the same time. Yet this is not practical as different charity logos will eventually neutralise each other.

An additional reason for the active documentation of corporate charitable activities includes employee-motivation and morale. Ideally, companies would have a forum for publishing corporate charitable activities arising from employee initiatives which are supervised and financed by company management. Another motivating reason for the active documentation of corporate charitable activities is that export-orientated companies use targeted sponsoring of matters of social concern in targeted markets to support successful entry into the market. Corporations can use their charitable efforts to improve their competitive context, such as the quality of the business environment in the locations where they operate. Such investments may improve a company's competitiveness by contributing to expanding the local market and helping to reduce corruption in the local business environment (Porter, M. E., supra).

Accordingly, there is a need in the art for an accurate method for connecting an interested party with an authoritative reference for corporate charitable giving, and in turn, making public the charitable activities of corporations. The present invention addresses this need.

### SUMMARY

An embodiment, by non limiting example, involves a method for providing a marketing and communications instrument for companies independent of size. In one embodiment, this is accomplished using an online platform. The online platform serves as a communication center for the participating parties. The charitable activities of customers can be stored in a computer having storage devices such as RAM and Removable Disk Drives. In another embodiment, providing marketing and communications instruments for companies is accomplished by documenting all corporate community, social and charitable activities under a label. Each activity receives its own comprehensible appearance. This concentrated presentation results in manageability and utilization for internal and external company communication. An independent source, such as “Charity Label” (hereinafter “CL”) offers customers, through a presentation of their donor activities, the opportunity to build up a growing donation documentation. This, through continuous additions and increasing of the number of donation presentations published by such an independent source, takes on the character of a donation history. In turn, the credibility of the presentation of the donor companies is increased.

In an exemplary embodiment, customers or companies use the independent source to present their non-profit, social and charitable engagements in society. In one embodiment, the independent source integrates many customers, lists donor organizations with their projects and offers schools and associations the possibility of reporting about their charitable activities free of charge. This will lead to a high number of visitors to CL, which in turn, will lead to corporations undertaking charitable activities publicly, which would not necessarily have been possible via a private website.

In a further embodiment, a user receives information about the non-profit, social and charitable engagement of the customers or companies, as well as a donor organization's projects. In one embodiment, user, customer, donor organization, school or general internet surfer selects a project and the independent source displays the project data and all data concerning donor activities is displayed in a copy-protected format. In another embodiment, the independent source offers in its web portal maximum options for conducting research and visitors who wish to inform themselves generally or about a certain specific company will also be encouraged to look for information on other listed companies. Thus, the independent source makes various new contacts accessible to the companies.

In a further embodiment, the invention comprises a computer implemented business method for providing an independent source of information regarding the charitable activities of a plurality of members. The method comprises enabling members to register with the independent source, such as the Charity Label organization. The method further comprises verifying member registration by checking entered data against previously entered, stored data, and maintaining a member database. The database stores information related to the charitable activities of the members, tracks charitable activities, receives updates regarding member charitable activities, and verifies information related to member charitable activities. Members pay an entrance fee once for their listing with the independent source, and may be assessed a monthly rate depending on the size of the member's company.

In an additional embodiment, verification of member donations and charitable activity occurs by requiring that members describe a specific charitable activity and provide a donation receipt of that activity to an individual associated with the independent source. For example, an individual at CL would independently confirm that the provided description and receipt is accurate.

In a further embodiment, the method comprises providing the members with a logo which may be displayed to a plurality of users indicating membership with the independent source. Members are entitled to use the logo on all of their products, printed matters, vehicles, and buildings in order to inform others of corporate membership with the independent source.

In a further embodiment, the method comprises providing an online platform accessible via the Internet to users, whereby users search and view information related to member charitable activity. In this way, members can inform users about their charitable activities, and users can obtain information about member donations by way of an independent source. Users may access the independent source free of charge and without registering. Through this system, there is a decoupling of advertising and donation presentation. The physical separation of advertising and donation activities on a documentation platform via an independent source promotes greater accuracy and clarity.

The foregoing embodiments are presented as exemplary, and do not limit the concept to any particular platform, method, or system.

### BRIEF DESCRIPTION OF THE DRAWINGS

FIG. 1 illustrates a CL online platform for providing communications between users and customers.

FIG. 2 is a block diagram of a computer-implemented data storage device interconnecting customers and users.

FIG. 3 is a flow diagram showing a working structure of Charitable Label.

FIG. 4 is a flow diagram of displaying a method of registering an interested party.

FIG. 5 is a flow diagram of displaying a verification of an interested party as a member.

FIG. 6 is a flow diagram displaying how a customer-created project is verified.

FIG. 7 is a flow diagram displaying a selection of options in the project overview.

FIG. 8 is a flow diagram displaying a project search.

FIG. 9 is a flow diagram showing a display format of a project search results.

FIG. 10 is a flow diagram displaying how a user finds a customer.

FIG. 11 is a flow diagram displaying a full text search.

### DETAILED DESCRIPTION

A method of active documentation of charitable activities using an independent source such as Charity Label (“CL”) is disclosed. The function of the CL independent source is based on a logo and an affiliated web portal. The label displayed on writings, products or seen in advertisements informs viewers about corporate chartable activities guides viewers so that they may obtain further information about corporate social engagements.

The independent source promotes the donor organizations which integrate CL into their charity advertising with an offer to always report free-of-charge about two of their current projects at CL. Thus, donor organizations obtain an additional permanent option for presenting their work. They are also provided with a page to report about emergency aid actions in response to recent catastrophes. This additional page is reserved just for this purpose. Companies that use their donation activities in a targeted manner for image-building purposes depend on information about projects and reliable donor organizations. CL provides exactly this information and allows a potential donor access to a donor organisation via the projects presented at CL. Donors who have not set up a new project for more than 12 months are informed that a donation history can be assembled based on continuous documentation.

Schools, youth groups, colleges, universities, etc. are invited to publish their charitable activities for free with the independent source, for example, at a website such as “www.charity-label.com.” The posting actions by students is part of the “network building” of the CL independent source. The aim is to award social engagement by publication and simultaneously to obtain technical competence by posting the actions themselves.

In another embodiment, the independent source may have designated partners. Partners of the independent source may be commercial or non-commercial. Non-commercial partners are all potential receivers of the donations in kind and of the cash donations. The independent source may offer non-commercial partners the option to inform users of current projects free of charge, and will guide users to partner web pages. This allows for a means for documenting donations through membership with the independent source. Commercial partners are all companies working in the marketing and public relations sector. There may be intensive cooperation between the independent source and the commercial partners to popularize the concept of connecting an interested party with an authoritative reference for charitable giving.

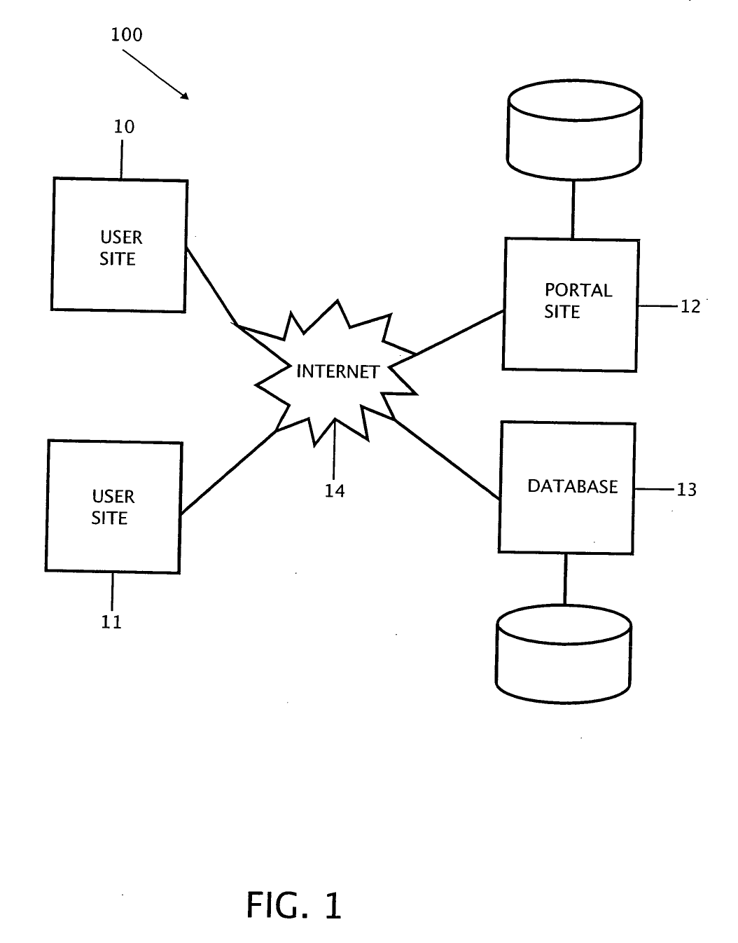

FIG. 1 illustrates a CL online platform 100 for providing communications between users and customers. CL online platform serves as a communications platform for the participating parties. Through this online platform, usually in the form of the internet 14, the user via user site 10 or 11 accesses to the database 12 or portal site 13 of the customer and receives information about the non-profit, social and charitable engagement of the customers, the donor organizations projects as well as actions by schools and associations. In addition, donor and non-profit organizations inform about their charitable projects through the same CL online platform.

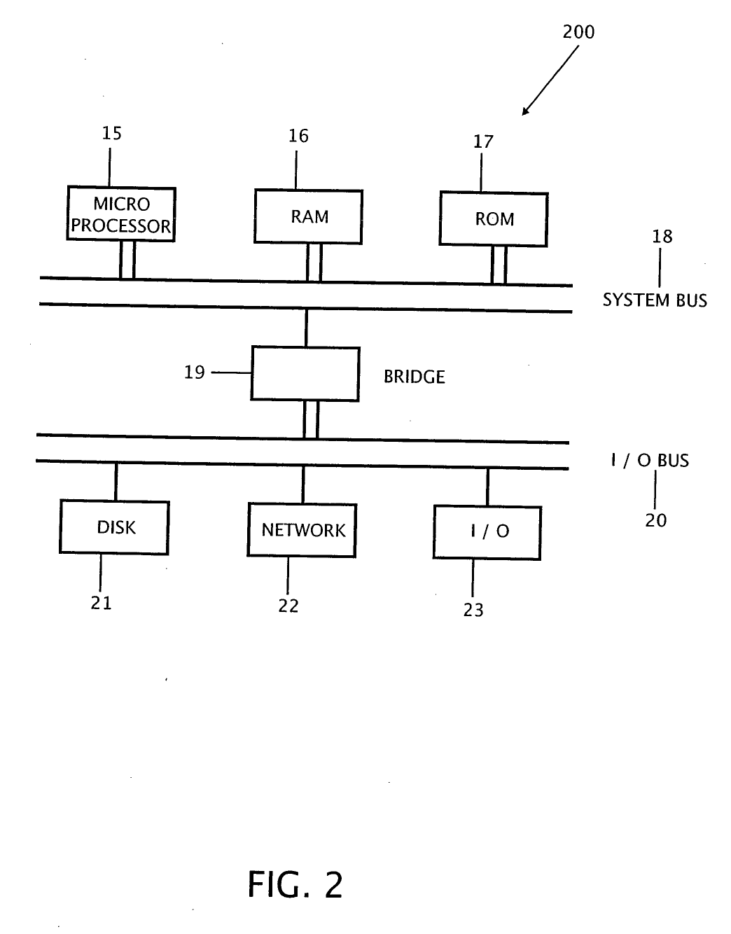

FIG. 2 is a block diagram 200 of computer-implemented data storage and communications device interconnecting customers and users. As illustrated, charitable activities of customers are stored in a computer having microprocessors 15, Random Access Memory (“RAM”) 16 and/or Read Only Memory (“ROM”) 17. The information stored travels each other through System Bus 18. The information also moves via Bridge 19 to storage device such as Disk 21, Network 22, or I/O 23. The same information can also be stored in a disk, through network or I/O. Information stored in disk, network, or I/O may travel each other through I/O Bus 20.

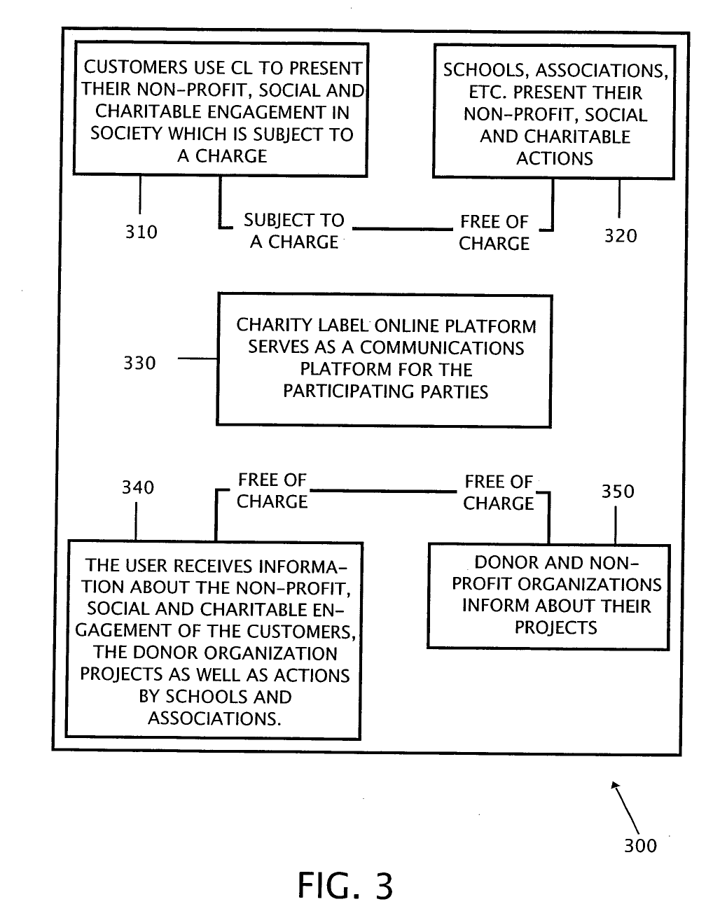

FIG. 3 is a flow diagram 300 showing a working structure of CL. Customers with charitable activities use CL to present their non-profit, social and charitable engagement in society 310. This is subject to a charge. Likewise, schools, associations and similar institutions present their non-profit, social and charitable activities 320 without being subject to a charge. CL online platform serves as a communications platform for the participating parties 330 as listed above as exemplary. Through this platform, the user receives information about the non-profit, social and charitable engagement of the customers, the donor organizations projects as well as actions by schools and associations 340 free of charge. In addition, donor and non-profit organizations inform about their charitable projects 350.

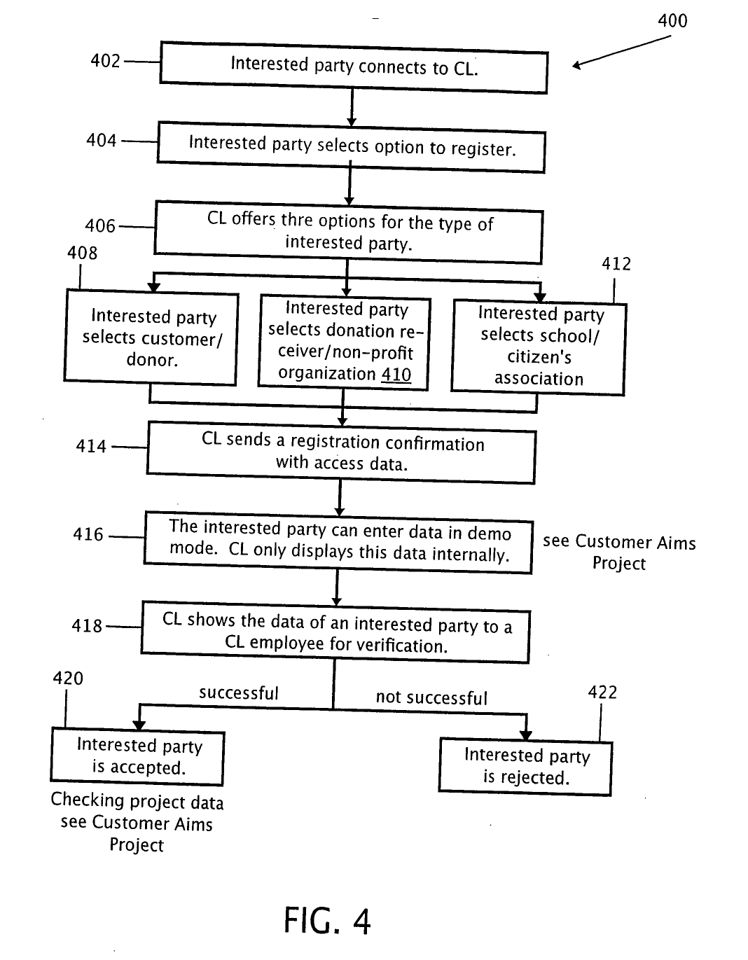

FIG. 4 is a flow diagram 400 showing a method of registering an interested party. An interested party connects CL 402 and selects option to register 404. CL offers three options for the type of an interested party 406. Option one allows the interested party to select customer/donor 408. Option two permits the interested party to choose donation receiver/non-profit organization 410. Option three grants the interested party to pick school/citizen's association 412. CL sends a registration confirmation with access data 414. The interested party can enter data in demo mode 416. CL shows the data of an interested party to a CL staff for verification purpose 418. If the verification is successful, the interested party is accepted 420; otherwise the interested party is rejected 422.

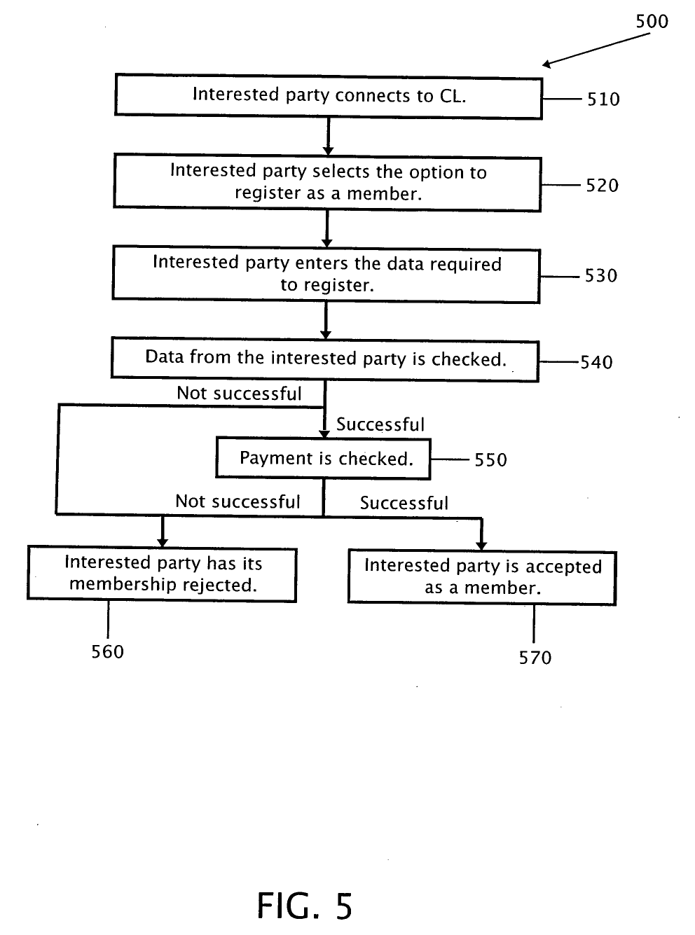

FIG. 5 is a flow diagram 500 displaying a verification of an interested party as a member. An interested party connects to CL 510 and selects the option to register as a member 520. The interested party enters the data required to register 530. The data from the interested party is verified 540. If the data is not successfully verified, the interested party has its membership denied 560. If the data is successfully verified, payment information is verified 550. If the payment information is cleared, then the interested party is accepted as a member 570.

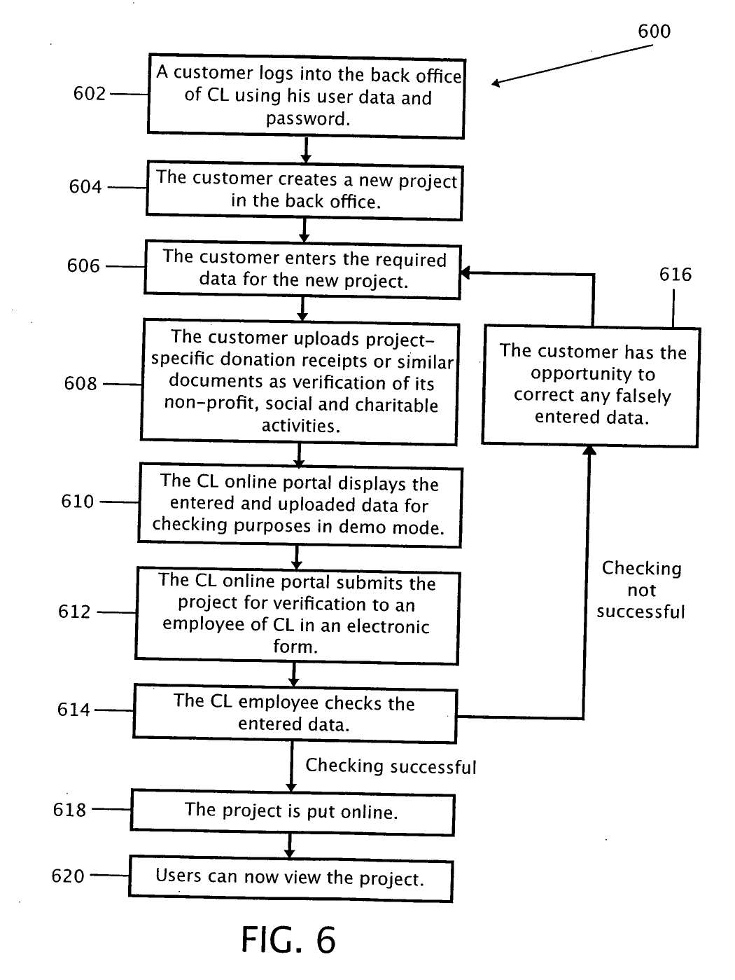

FIG. 6 is a flow diagram 600 displaying how a customer created project is verified. A member customer logs into the back office of CL using his user data and password 602. The customer creates a new project in the back office 604. The customer enters the required data for the new project 606. The customer then uploads project-specific donation receipts or similar documents as verification of its non-profit, social and charitable activities 608. The CL online portal displays the entered and uploaded data for verifying purposes in demo mode 610. The CL online portal submits the project for verification to a CL staff in an electronic form 612. The CL staff checks the entered data 614. If the verification is successful, the entered project is put online 618 for users to review the project 620. If the verification is not successful, the customer has the opportunity to correct any falsely entered data 616 and the process starts again by re-entering the required data for the new project 606.

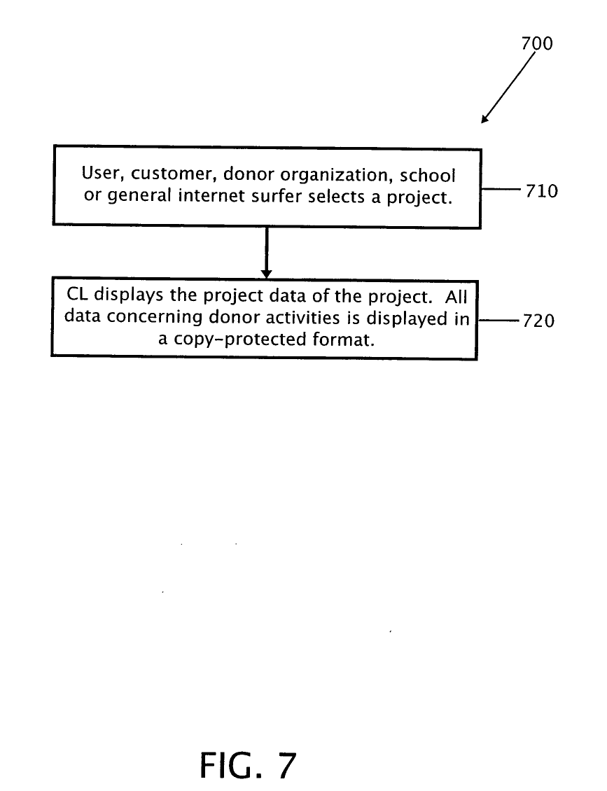

FIG. 7 is a flow diagram 700 displaying a selection of options in the project overview. Users, customers, donor organizations, schools or general internet surfers select a project 710. CL then displays the data of the project selected 720. All data regarding donor activities is displayed in a copy-protected format.

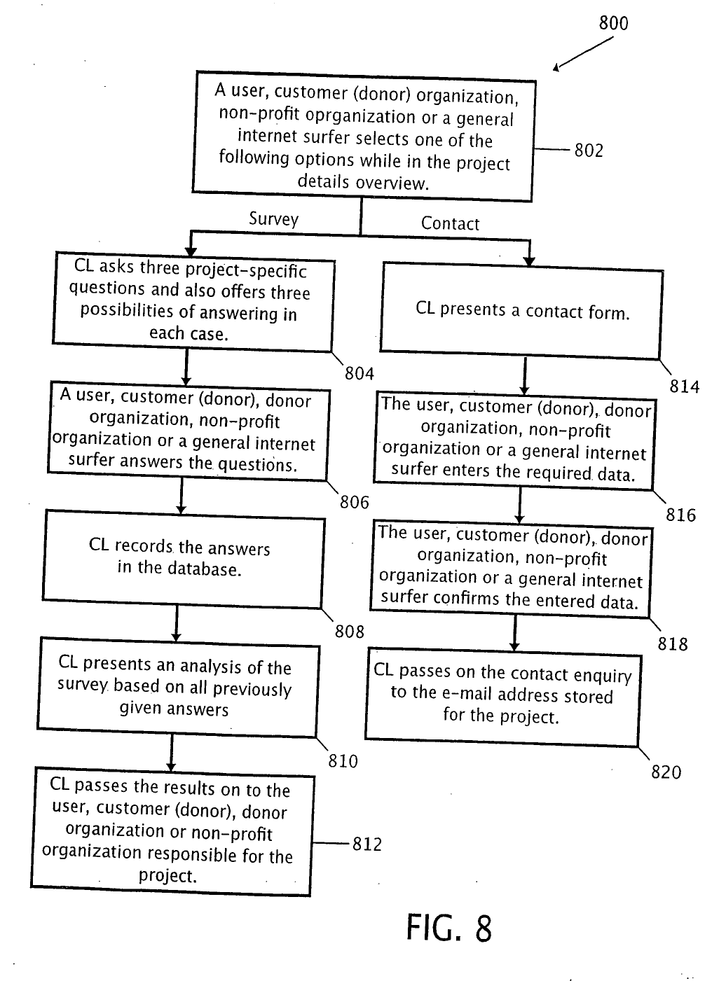

FIG. 8 is a flow diagram 800 displaying how a project search is performed. A user, customer (donor), donor organization, non-profit organization or a general internet surfer selects one of the following options while in the project details overview 802. In survey option, CL asks three project-specific questions and also offers three possibilities of answering in each question 804. A user, customer (donor), donor organization, non-profit organization or a general internet surfer answers the questions 806. CL records the answers provided in the database 808. CL presents an analysis of the survey based on all previously given answers 810. CL passes the results on to the user, customer (donor), donor organization, and non-profit organization responsible for the project 812. In contact option, CL presents a contact form to fill out 814. The user, customer (donor), donor organization, non-profit organization or a general internet surfer enters the required data 816. The user, customer (donor), donor organization, non-profit organization or a general internet surfer confirms the entered data 818. CL passes on the contact inquiry to the e-mail address stored for the project 820.

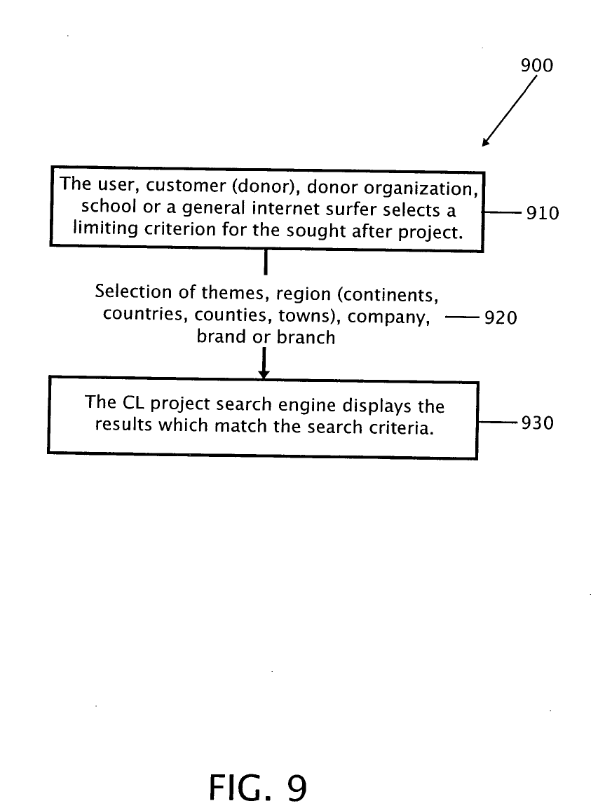

FIG. 9 is a flow diagram 900 showing a display format of a project search results. The user, customer (donor), donor organization, non-profit organization or a general internet surfer selects a limiting criterion for the sought after project 910. The limiting criteria include themes, region (continents, countries, counties, and/or towns), company, brand or branch 920. The CL project search engine displays the results which match the search criteria 930.

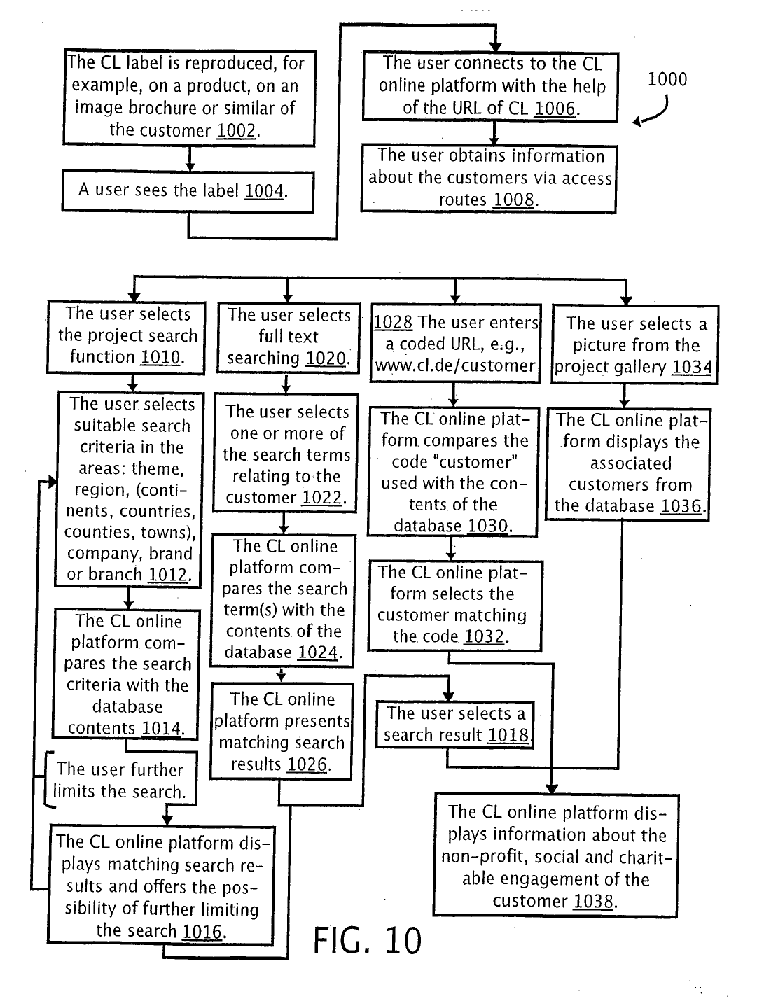

FIG. 10 is a flow diagram 1000 displaying how a user finds a customer. The CL label is reproduced, for instance, on a product, in an image brochure or similar of the customer 1002. A user sees the label reproduced 1004. The user connects to the CL online platform with the help of the URL of CL 1006. The user then obtains information about the customers via various access routes 1008. The following routes are exemplary, and the present invention is not limited to the following examples. Route one comprises the following: the user selects the project search function 1010; the user selects suitable search criteria in the areas such as themes, region (continents, countries, counties, and/or towns), company, brand or branch 1012; the CL online platform compares the search criteria with the database contents 1014; the CL online platform displays matching search results and offers the possibility of further limiting the search 1016; the user selects a search result 1018; and the CL online platform displays information on about the non-profit, social and charitable engagement of the customer 1038. Route two comprises the following: the user selects full text searching 1020; the user selects one or more of the search terms relating to the customer 1022; the CL online platform compares the search term(s) with the contents of the database 1024; the CL online platform presents matching search results 1026; the user selects a search result 1018; and the CL online platform displays information on about the non-profit, social and charitable engagement of the customer 1038. Route three comprises the following: the user enters a coded URL 1028, e.g. www.cl.de/customer; the CL online platform compares the code “customer” used with the contents of the database 1030; the CL online platform selects the customer matching the code 1032; and the CL online platform displays information on about the non-profit, social and charitable engagement of the customer 1038. Route four comprises the following; the user selects a picture from the product gallery 1034; the CL online platform displays the associated customers from the database 1036; and the CL online platform displays information on about the non-profit, social and charitable engagement of the customer 1038.

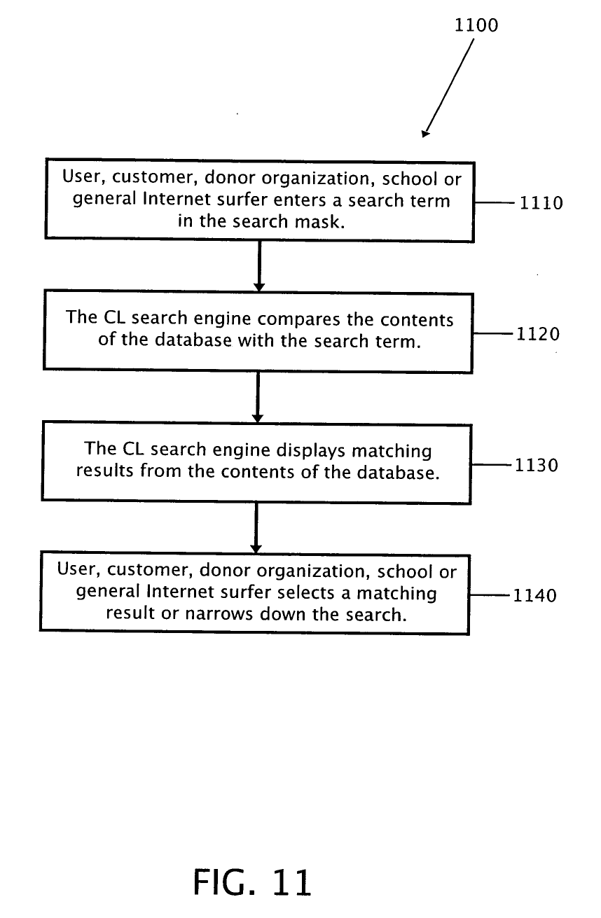

FIG. 11 is a flow diagram 1100 displaying a full text search. User, customer, donor organization, school or general internet surfer enters a search term in the search mask 1110. The CL search engine compares the contents of the database with the search term 1120. The CL search engine displays matching results from the contents of the database 1130. Then user, customer, donor organization, school or general internet surfer selects a matching result or narrows down the search 1140.

It is claimed:

1. A computer implemented business method for providing an independent source of information regarding charitable activities of a plurality of members, said method comprising:
enabling said plurality of members to register with said independent source;
verifying registration of said plurality of members;
maintaining a database of a plurality of members, said database storing information related to charitable activities of said plurality of members;
tracking charitable activities of said plurality of members;
receiving updates regarding said charitable activities of said plurality of members;
verifying information related to said charitable activities of said plurality of members;
providing said plurality of members a logo said plurality of members may display to a plurality of users to indicate membership with said independent source;
providing an online platform accessible via the Internet to said plurality of users; and
enabling said plurality of users to search and view said information related to charitable activity of said plurality of members,
whereby said members can advertise to said plurality of users said charitable activities, and said plurality of users can obtain information about said charitable activities of said plurality of members from said independent source.

2. The method of claim 1 wherein said plurality of members includes not-for-profit entities that can access and make use of the independent source to inform said plurality of users about charitable projects free-of-charge.

3. The method of claim 1 wherein said plurality of members includes for-profit entities that can access and make use of the independent source to inform said plurality of users about charitable projects for a specified charge.

4. The method of claim 1 wherein verifying registration of said plurality of members involves checking entered data against previously entered, stored data.

5. The method of claim 1 wherein verifying information related to said charitable activities of said plurality of members requires that said members:
a) describe a specific charitable activity, and
b) provide a donation receipt of said activity to an individual associated with the independent source, whereby said individual checks that said description is correct.

6. The method of claim 1 wherein said plurality of members are entitled to use said logo on all products, printed matters, vehicles, and buildings in order to inform others of membership in said independent source.

7. The method of claim 1 wherein said plurality of users obtain information about specific members through various routes of access, including, but not limited to:
a) selecting limiting criteria through said online platform for a specific charitable project whereby a search engine displays results that match the search criteria;
b) using a text search function through said online platform whereby the terms searched refer to a specific member and the platform presents matching results; or
c) entering a coded uniform resource locator (URL) which designates a named member, whereby the platform compares the named member with the contents of a member database, selects the member name matching said code and displays information regarding the charitable activities of said member.

8. The method of claim 1 wherein said plurality of users have seen said logo and seek information about the charitable activities of said members, whereby said users may access said online platform free-of-charge and without registering.

9. The method of claim 1 wherein said independent source has a plurality of partners, said partners being potential receivers of donations.

10. The method of claim 9 wherein said partners are not-for-profit entities.

11. The method of claim 9 wherein said partners are for-profit entities.

12. A computer-readable medium comprising computer-executable instructions comprising:
enabling said plurality of members to register with said independent source;
verifying registration of said plurality of members;
maintaining a database of a plurality of members, said database storing information related to charitable activities of said plurality of members;
tracking charitable activities of said plurality of members;
receiving updates regarding said charitable activities of said plurality of members;
verifying information related to said charitable activities of said plurality of members;
providing said plurality of members a logo said plurality of members may display to a plurality of users to indicate membership with said independent source;
providing an online platform accessible via the Internet to said plurality of users; and
enabling said plurality of users to search and view said information related to charitable activity of said plurality of members,
whereby said members can advertise to said plurality of users said charitable activities, and said plurality of users can obtain information about said charitable activities of said plurality of members from said independent source.

13. A computer implemented business method for allowing a plurality of members to inform a plurality of users of charitable activities through an independent source comprising:
enabling said plurality of members to register with said independent source;
providing an online platform accessible via the Internet to said plurality of members;
enabling said plurality of members to create project descriptions, upload project-specific donation receipts or similar documents as verification of said charitable activities; and
enabling said plurality of users to search and view said information related to charitable activity of said plurality of members.

14. A computer implemented business method for providing an independent source of information regarding charitable activities of a plurality of members, said method comprising:
enabling said plurality of members to register with said independent source;
verifying registration of said plurality of members by checking entered data against previously entered, stored data;
maintaining a database of a plurality of members, said database storing information related to charitable activities of said plurality of members;
tracking charitable activities of said plurality of members;
receiving updates regarding said charitable activities of said plurality of members;
verifying information related to said charitable activities of said plurality of members by requiring that said members:
a) describe a specific charitable activity, and
b) provide a donation receipt of said activity to an individual associated with the independent source, whereby said individual checks that said description is correct;
providing said plurality of members a logo said plurality of members may display to a plurality of users to indicate membership with said independent source;
providing an online platform accessible via the Internet to said plurality of users; and
enabling said plurality of users to search and view said information related to charitable activity of said plurality of members,
whereby said members can advertise to said plurality of users said charitable activities, and said plurality of users can obtain information about said charitable activities of said plurality of members from said independent source.
